(19) United States
(12) Patent Application Publication
(10) Pub. No.: US 2005/0141492 A1
(43) Pub. Date: Jun. 30, 2005

(54) Subscriber station

(76) Inventor: Frank Siu Hong Chan, Scarborough (CA)

Correspondence Address: TORYS LLP, 79 WELLINGTON ST. WEST, SUITE 3000, TORONTO, ON, M5K 1N2, CA

(21) Appl. No.: 11/002,076

(22) Filed: Dec. 3, 2004

(30) Foreign Application Priority Data
Dec. 30, 2003 (CA) 2,454,408

(51) Int. Cl. H04L 12/66

(52) U.S. Cl. 370/355

(57) ABSTRACT

A subscriber station and various methods and systems associated therewith are provided. An embodiment includes a DSL based system wherein the subscriber station includes the functionality of a DSL modem. The modem is operable to execute a web-based management session that executes in a first communication band, and that can be made available at a management console located outside of the private network located at the subscriber station. The modem is also operable to listen for an activation signal via a communication band that is outside of the first communication band. The web-based management session is activated upon receipt of the out-of-band activation signal.

### PRIORITY CLAIM

The present application claims priority from Canadian Patent Application Number 2,454,408, filed Dec. 30, 2003, the contents of which are incorporated herein by reference.

### FIELD OF THE INVENTION

The present invention relates generally to computer networking and more particularly to a subscriber station.

### BACKGROUND OF THE INVENTION

Solving the “last-mile” problem has been an important piece of providing ubiquitous, high-speed Internet access to business and residential customers (“subscribers”) at their premises. Digital Subscriber Line (“DSL”) and CATV Internet services, are now well-entrenched means of solving the last-mile problem.

A common feature of last mile solutions is a switching station that has a gateway connected to the Internet via a backhaul, such as a T1, T3, or a virtual network or the like. The gateway interfaces the backhaul with the particular communication medium or channel used to deliver the Internet service to the subscriber premises.

In DSL (and its variants, commonly referred to XDSL) the switching station is typically a central office as commonly found in the public switched telephone network (“PSTN”), and the gateway is a Digital Subscriber Line Access Multiplexer (“DSLAM”). The communication medium is typically the traditional twisted pair of copper wires that run between the central office and subscriber premises, and normally connect to a plain old telephone service (“POTS”) telephone in the subscriber premises. Where the subscriber is a DSL customer, the twisted pair of copper wires in the customer premises are also connected to a DSL modem, which in turn connects to the subscriber's computer or intranet.

Problems with the foregoing arise when a subscriber loses, or believes they have lost, Internet connectivity. To troubleshoot this problem, it is common for the service provider to send a service technician to the subscriber premises. To verify Internet connectivity, the service technician can attempt to make their own Internet connection from the subscriber premises in order to assess whether a connectivity problem actually exists, and if so, to attempt to determine the nature of the problem. However, such use of service technicians can be wasteful, particularly where the technician discovers that no connectivity problem exists and that the subscriber's problems are in fact related to the subscriber's proprietary equipment, or other equipment located at the subscriber's premises. Another common issue is that a firewall running in the subscriber station may need to have its firmware updated, and yet this also typically requires the physical presence of someone at the subscriber station to make these update.

It is also known to provide subscriber stations (i.e. DSL modems, Cable modems, Internet Routers and/or appropriate combinations thereof) with web-based management sessions for configuring the subscriber station. Such configurations typically include settings relating to security, internet protocol (“IP”) addresses ranges etc. In the DSL modem environment, it is also common to include a management session so that the subscriber can provide user-id and password used for the Point-to-Point Protocol Over Ethernet (“PPPoE”) that is common to DSL networks. However, due to security concerns such web-based management sessions are rarely made available outside the private network and over public networks, thereby limiting the ability to control the subscriber station from the private network. Another concern with leaving management sessions open to the public network is the consumption of resources inside the subscriber station needed to operate the management sessions—it can therefore be preferred to invoke the management sessions as needed thereby keep resources available on the subscriber station for processing of network traffic. As a result, service technicians still need to be dispatched to the subscriber premises in order to access such management sessions and make appropriate modifications thereto.

### SUMMARY OF THE INVENTION

It is an object of the present invention to provide a novel subscriber station remote control system and method that obviates or mitigates at least one of the above-identified disadvantages of the prior art.

An aspect of the invention provides a subscriber station comprising first and second interfaces for connection to first and second networks respectively, each of the networks having a first medium associated therewith. The subscriber station also includes a microprocessor interconnecting the interfaces and for communicating transmissions between the networks. The subscriber station also includes a persistent storage device connected to the microprocessor for storing a management session executable on the microprocessor. The management session is operable to control the transmissions according to configurations made to the management session over the first medium. The management session can be activated via an activation signal sent over another medium that is different from the first medium.

The subscriber station can include functionality selected from the group consisting of an xDSL modem, a cable modem, a routing device, a firewall, a set-top box and a wireless local loop subscriber station.

Where the subscriber station is an xDSL modem, the first interface is connectable to a DSLAM via a twisted pair. The second interface is connectable to a client either directly or via an Intranet. In this case, the subscriber station is operable to carry Internet communications between the client and the DSLAM.

The first network can be the Internet and the second network can be an Intranet. The first medium can include at least one of layers three through seven of the OSI reference model. The another medium can be layer one of the OSI reference model, or some other medium that is different from layers three through seven of the OSI reference model.

Where the another medium is layer one, then the activation signal can include at least one “Sync” signal, or the signal can includes a plurality of “Sync” signals sent over predetermined intervals that are recognizable to the management session.

The activation signal used for activation of the management session can also be based on activation of a physical switch located on an exterior of the subscriber station.

The another medium can be layer two of the OSI reference model. In this case the activation signal can be based on a predefined code sent via the vendor proprietary segment of the specification as defined in International Telecommunications Standard (“ITU”) Telecommunication Standardization Sector (“ITU-T”) G. 992.1, dated July 1999.

The configurations can be made over a secure channel established over the first medium. More particularly, where the first network is the Internet and the management session is a web-based application, then the secure channel can be a secure socket layer (“SSL”).

The management session can require authentication of a user at least once after activation and prior to permitting changes to the configurations.

The management session can send an acknowledgement to a source of the signal after receipt thereof, regardless of whether the session is successfully activated.

The source of the activation signal can be a management console associated with a service provider respective to the subscriber station.

### BRIEF DESCRIPTION OF THE DRAWINGS

The invention will now be described by way of example only, and with reference to the accompanying drawings, in which:

FIG. 1 is a schematic representation of a subscriber station and a system associated therewith in accordance with an embodiment of the invention;

FIG. 2 is a schematic representation of the management session application stored on the subscriber station of FIG. 1;

FIG. 3 shows the management session of FIG. 2 in the closed state;

FIG. 4 shows the management session of FIG. 2 in the open state;

FIG. 5 shows a flowchart depicting a method of controlling a subscriber station according to another embodiment of the invention;

FIG. 6 shows the management session of FIG. 2 in accordance with another embodiment of the invention;

FIG. 7 shows the management session of FIG. 6 when performing the method of FIG. 5;

FIG. 8 shows the management session of FIG. 6 when performing the method of FIG. 5;

FIG. 9 shows the management session of FIG. 6 when performing the method of FIG. 5; and,

FIG. 10 shows the management session of FIG. 2 in accordance with another embodiment of the invention.

### DETAILED DESCRIPTION OF THE INVENTION

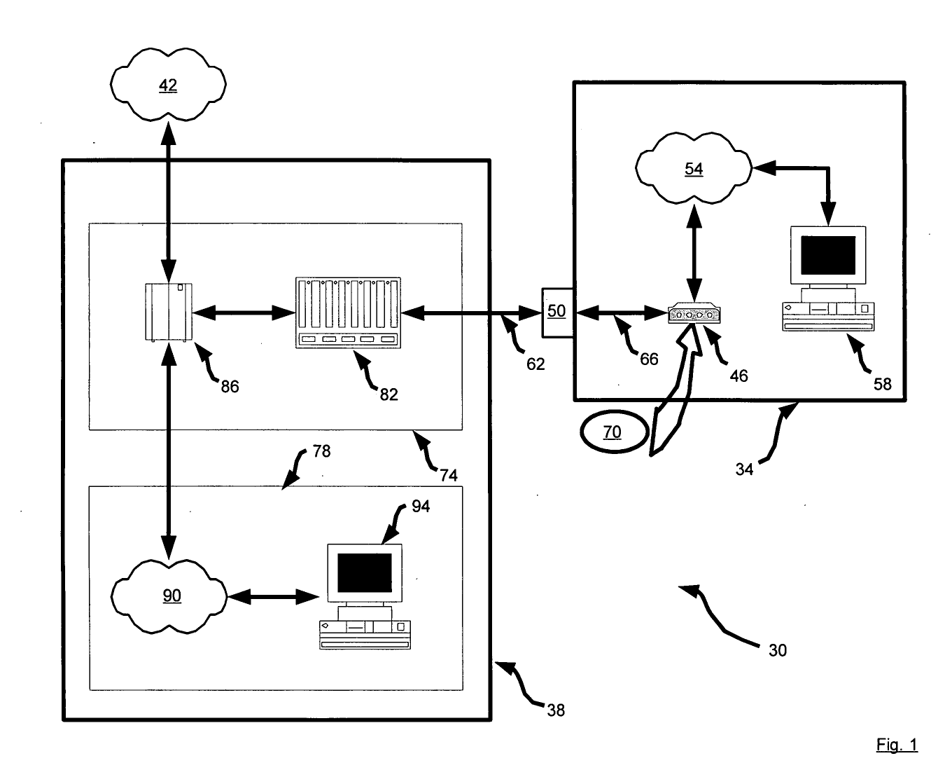

Referring now to FIG. 1, a subscriber station remote control system is indicated generally at 30. System 30 includes at least one subscriber premises 34 that is connected to a service provider 38, which in turn is connected to a public network which in the present embodiment is the Internet 42.

Subscriber premises 34 includes a subscriber station 46 which lies intermediate a junction 50 and a private network, which in the present embodiment is an Intranet 54. In turn, Intranet 54 connects to at least one Client 58. Client 58 is any computing device, such as a personal computer, a server, a television set-top box, a personal digital assistant or the like that is operable to conduct communications over Intranet 54 as well as Internet 42. By the same token, Intranet 54 can be based on any wired or wireless protocols and infrastructures now or in the future used to provide private network services, including Ethernet, 802.11b, Bluetooth, or the like. In its simplest form, intranet 54 can simply be a link, such as an Ethernet cable, that directly connects client 58 to subscriber station 46. Alternatively, intranet 54 can be a more complex configuration of hubs, routers, switches, wireless access points, combined with a plurality of other clients, printers, servers and other computing devices connected thereto.

System 30 is based on xDSL, and service provider 38 is a traditional telephone company that provides high speed Internet access to subscriber premises 34 via a plain old telephone system (“POTS”) copper wire twisted pair 62. It should be understood that twisted pair 62 represents all of the components that typically lie along the path of pair 62, including junction boxes, bridges etc. Because they are not necessary, system 30 does not show the other traditional POTS infrastructure such as switches and handsets.

In order to demarcate infrastructure responsibility between subscriber premises 34 and service provider 38, twisted pair 62 terminates at junction 50, and resumes thereafter with a subscriber premises twisted pair 66 that connects junction 50 to subscriber station 46. Thus, infrastructure inside subscriber premises 34 is the responsibility of the subscriber, whereas all infrastructure inside service provider 38, including twisted pair 62, is the responsibility of service provider 38.

It is to be understood that the teachings herein of system 30 are applicable to other present day or future “last mile solutions”, in addition to xDSL, including but not limited to high speed Internet over cable, Internet over satellite, and wireless local loop. But, in a present embodiment, subscriber station 46 includes the functionality of a traditional xDSL modem and is thereby able to effect Internet-type network communications between Intranet 54 and Internet 42 via service provider 38. Subscriber station 46 can also include the functionality of other devices, such as a firewall, router and gateway etc.

Subscriber station 46 also includes a management session application 70 stored in the firmware of station 46 that can be used to configure subscriber station 46. Management session 70 executes as a web-based application over various networks in system 30, and can be activated by a signal that is out-of-band from the protocol layer on which session 70 actually executes. Further details about management session 70 will be explained in greater detail below.

It is to be clarified that the particular equipment configuration of subscriber premises 34 is merely exemplary, and other configurations of subscriber premises can include any number of other communication appliances and arrangements thereof, such as POTS telephone handsets, a private branch exchange (“PBX”), wireless access point (“WAP”), etc. Additionally, it is to be reiterated that subscriber premises 34 can belong to residential, business or any other type of subscriber.

Service provider 38 is characterized by at least one central office 74 and a network control centre 78. Central office 74 includes a Digital Subscriber Line Access Multiplexer (“DSLAM”) 82 that connects a router 86 with subscriber station 46. DSLAM 78 is any known DSLAM such as the Alcatel Standard Density DSLAM, Model 1000 ADSL from Alcatel USA, Inc., 3400 W. Plano Parkway, Plano, Tex. 75075, or the Alcatel High HI Density DSLAM, Model 7300 ASAM also available from Alcatel USA, Inc. In turn, router 86 can direct traffic from Internet 42 and control centre 78 to subscriber station 46 via DSLAM 82.

Control centre 78 includes an internal network 90 that can interconnect to a plurality of central offices 74 with at least one management console 94. Management console 94 is a computing device such as a personal computer that is operated by a customer service representative of service provider 38. Management console 94 is operable to interact with a variety of network components relating to system 30, including providing information about the hardware, software and network status of Internet 42, central office 74 and the like. Additionally, management console 94 is operable to activate management session 70 on subscriber station 46 and thereby remotely configure subscriber station 46.

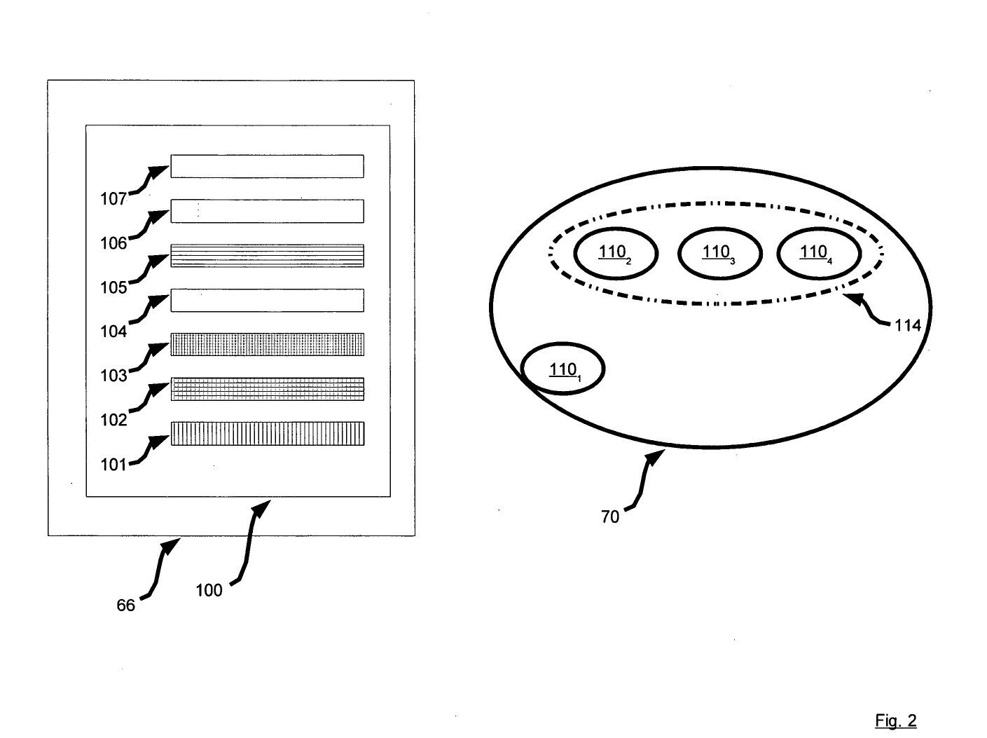

Referring now to FIG. 2, management session 70 is shown in greater detail, and in particular how management 70 interacts with the network protocol stack 100 that is associated with twisted pair 66 and other network components of system 30. In a present embodiment, network protocol stack 100 is based on the Open Systems Interconnect (“OSI”) reference model, and thus includes a physical layer 101, a data link layer 102, a network layer 103, a transport layer 104, a session layer 105, a presentation layer 106 and an application layer 107. Management session 70 includes a plurality of software objects 110. Each object 110 represents different aspects of functionality of management session 70, and can thus be implemented in other ways other than objects depending on the programming language or other software or hardware environment used to implement session 70. More particularly, object 1101 is used to activate management session 70, and to activate other objects 110 in session, such remaining objects being collectively indicated at 114 in FIG. 2.

Of particular note, object 1101 does not directly interact with any portion of protocol stack 100 that is used by the remaining objects 114, and accordingly management session 70 is activated by out-of-band means. Remaining objects 114 are directed to the actual functionality associated with management session 70, which can be used to configure subscriber station 46. For example, object 1102 can be used to set the user-id and password for authentication of the subscriber that owns Intranet 54 with service provider 38, as is commonly found in the Point-to-Point Protocol Over Ethernet (“PPPOE”) that is commonly employed by xDSL service providers. As an additional example, object 1103 can be used to open or close various IP ports on subscriber station 46, thereby giving a measure of control over the types of IP traffic that can enter or leave Intranet 54. As an additional example, object 1104 can be used to configure a Dynamic Host Configuration Protocol (“DHCP”) server within subscriber station 46, such that subscriber station 46 is operable to dynamically assign private network IP addresses to devices on Intranet 54, such as client 58. These examples of functions of objects 1102, 1103 and 1104 will be used in the discussion below, and at such times object 1102 will be referred to as authentication object 1102; object 1103 will be referred to as port-control object 1103; and object 1104 will be referred to as DHCP object 1104.

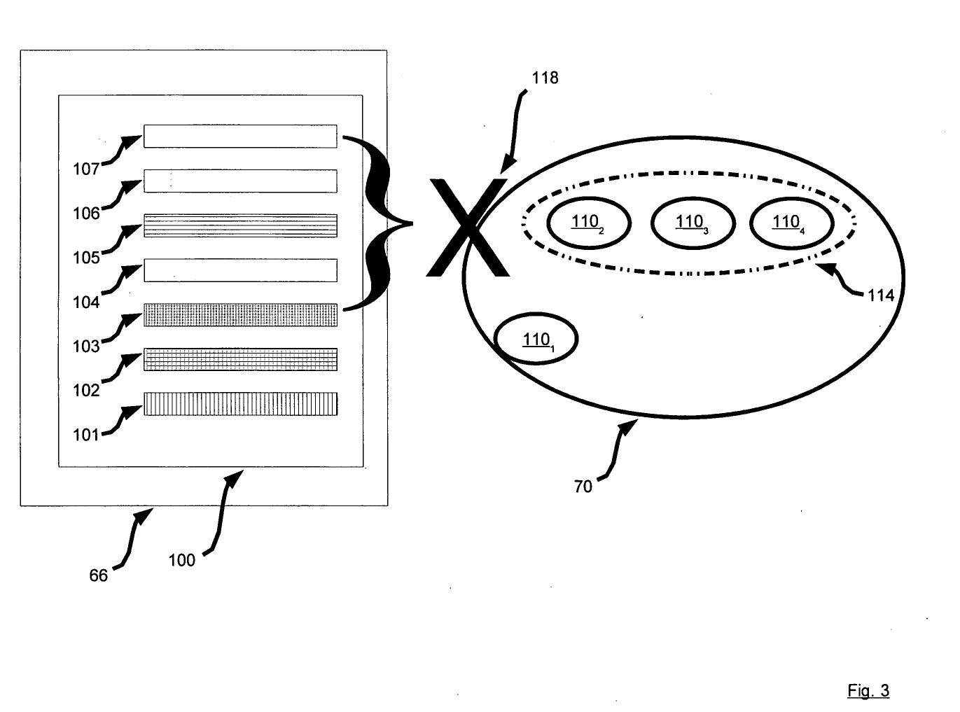

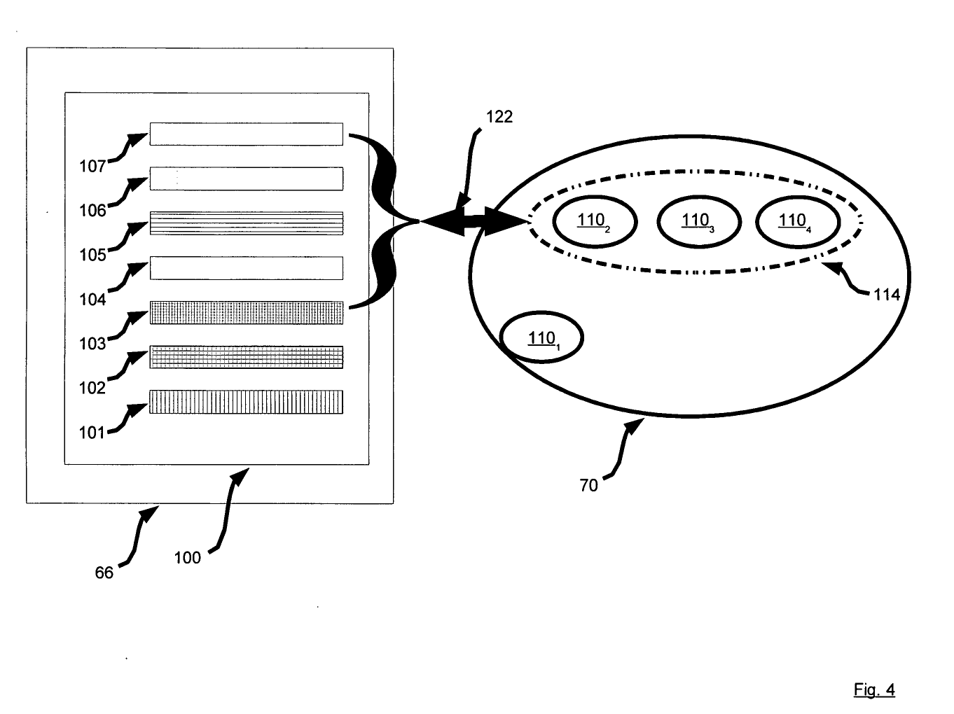

Continuing with this example, it will be assumed that remaining objects 114 each interact with at least one of layers 103, 104, 105, 106 and 107. This example is shown in FIGS. 3 and 4. In FIG. 3, session 70 is shown in a closed state, wherein layers 103, 104, 105, 106 and 107 are shown closed to remaining objects 114 by means of an “X” indicated at 118. In contrast, in FIG. 4 session 70 is shown in an active state, wherein layers 103, 104, 105, 106 and 107 are shown open to remaining objects 114 by means of a double-arrow indicated at 122.

Accordingly, object 1101 is operable to change session 70 between the closed state shown in FIG. 3 and the active state shown in FIG. 4. Object 1101 is also operable to interact with the remainder of system 30 out-of-band from layers 103, 104, 105, 106 and 107. Thus, in the present embodiment, the terms in-band means the end-to-end relationship between client 58 and Internet 42 over the protocol layers 103, 104, 105, 106 and 107, while out-of-band means any thing that is outside of this path and not at protocol layers 103, 104, 105, 106 and 107.

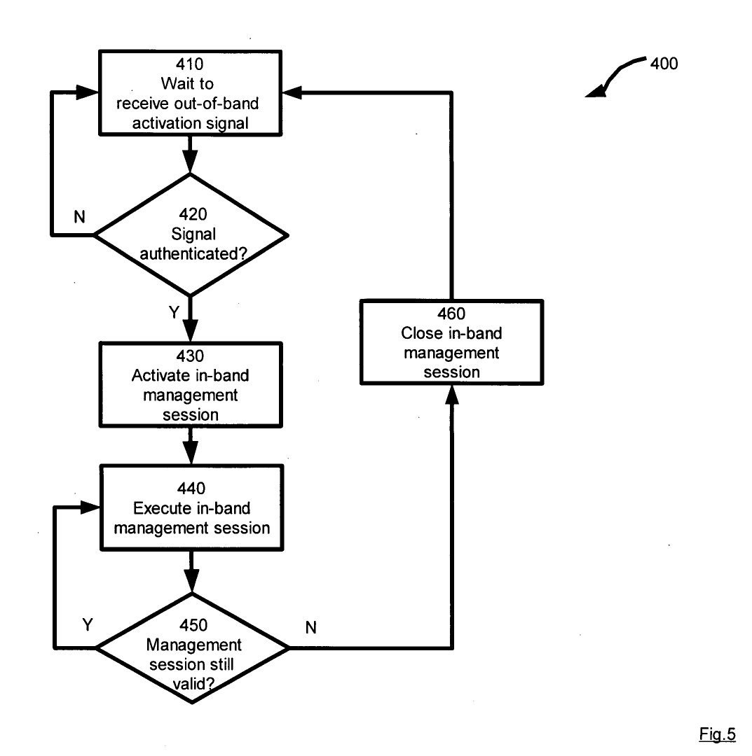

Various ways of implementing this out-of-band interaction are contemplated. In order to help explain certain of these implementations and various other aspects of system 30, reference will now be made to FIG. 5 which shows a method for remotely controlling a subscriber station and which is indicated generally at 400. In order to assist in the explanation of the method, it will be assumed that method 400 is operated using system 30. However, it is to be understood that system 30 and/or method 400 can be varied, and need not work exactly as discussed herein in conjunction with each other, and that such variations are within the scope of the present invention.

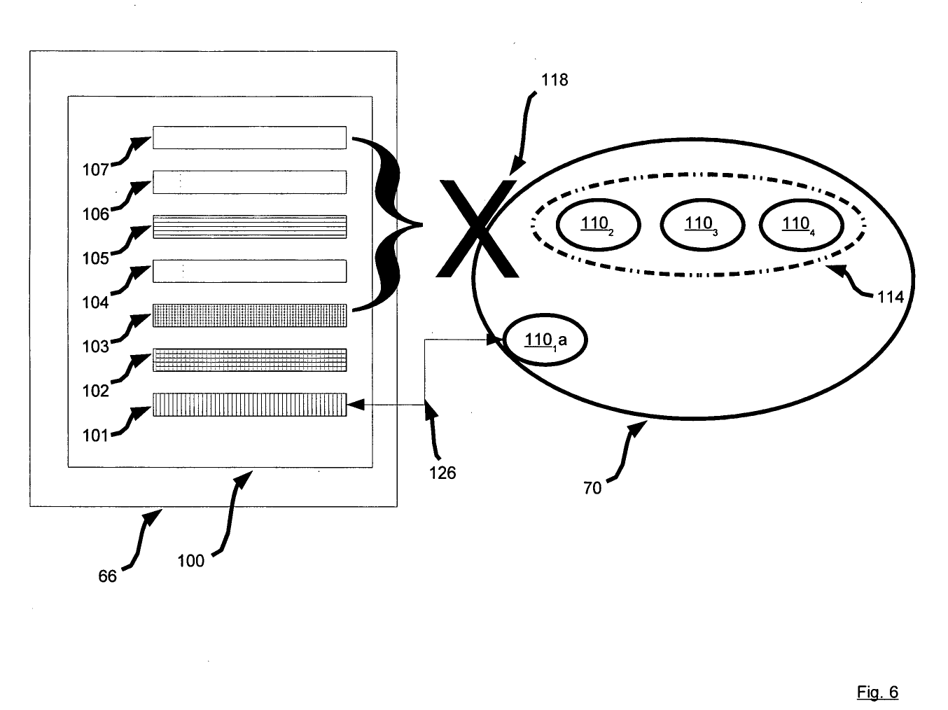

Before discussing method 400, certain assumptions will be made about system 30. Referring now to FIG. 6, it will be assumed that system 30 is in the closed state (previously shown in FIG. 3). It will also be assumed that object 1101 is implemented as object 1101a, and that object 1101a is operable to ‘listen’ for communications sent over layer 101 of protocol stack 100, as represented by link 126.

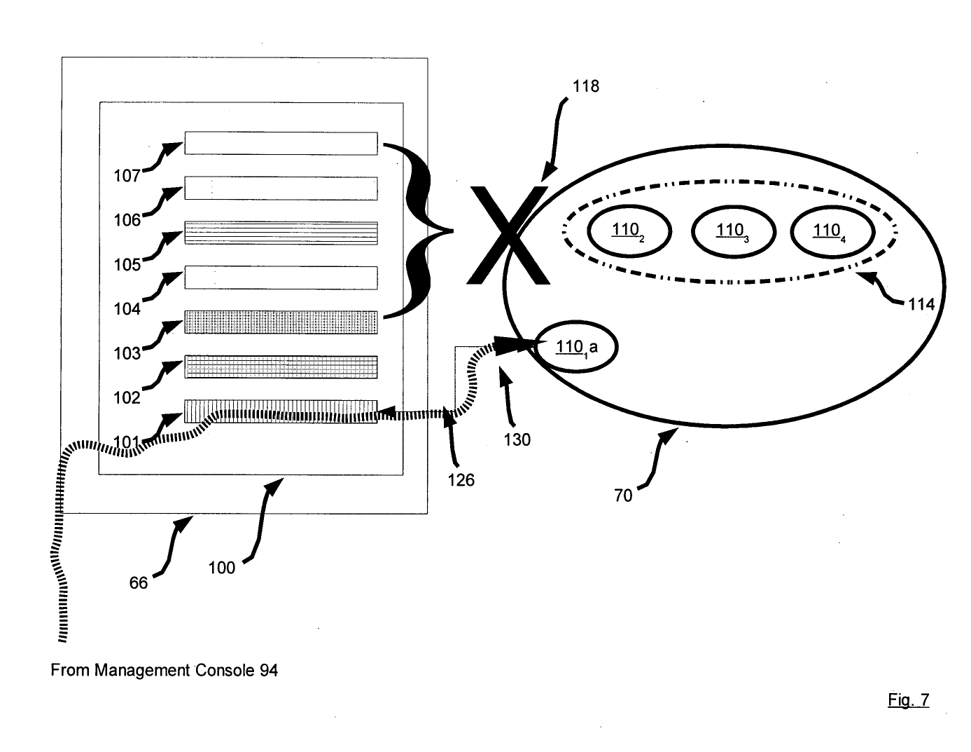

Thus, beginning first at step 410, object 1101a waits to receive an out-of-band activation signal. This ‘waiting’ is represented in FIG. 6 as object 1101a listens over link 126 to layer 101, waiting for an activation signal. The receipt of the out-of-band activation signal is represented in FIG. 7 as management console 94 sends an out-of-band activation signal, indicated at 130, over physical layer 101 of twisted pair 66, where it is received by object 1101a. In this particular embodiment, the activation signal takes the form of a traditional “Sync” signal as is currently already employed in the xDSL modem environment, with the exception that object 1101a is configured to respond to the traditional “Sync” signal in the novel manner described herein. As a potentially more secure variation to simply sending one “Sync” signal, out-of-band signal 130 can be a plurality of “Sync” signals sent over a predefined interval recognizable to object 1101a.

Method 400 thus advances to step 420 where the signal sent at 410 is authenticated. Thus, in the example of signal 130 being comprised of a plurality of “Sync” signals sent over a predefined intervals, object 1101a would consider such signals to be authenticated if the “Sync” signals were received according to a recognized pattern, and at this point the authentication signal 130 would be considered authenticated and method 400 would advance to step 430. However, if for any reason authentication failed, method 400 would return to step 410.

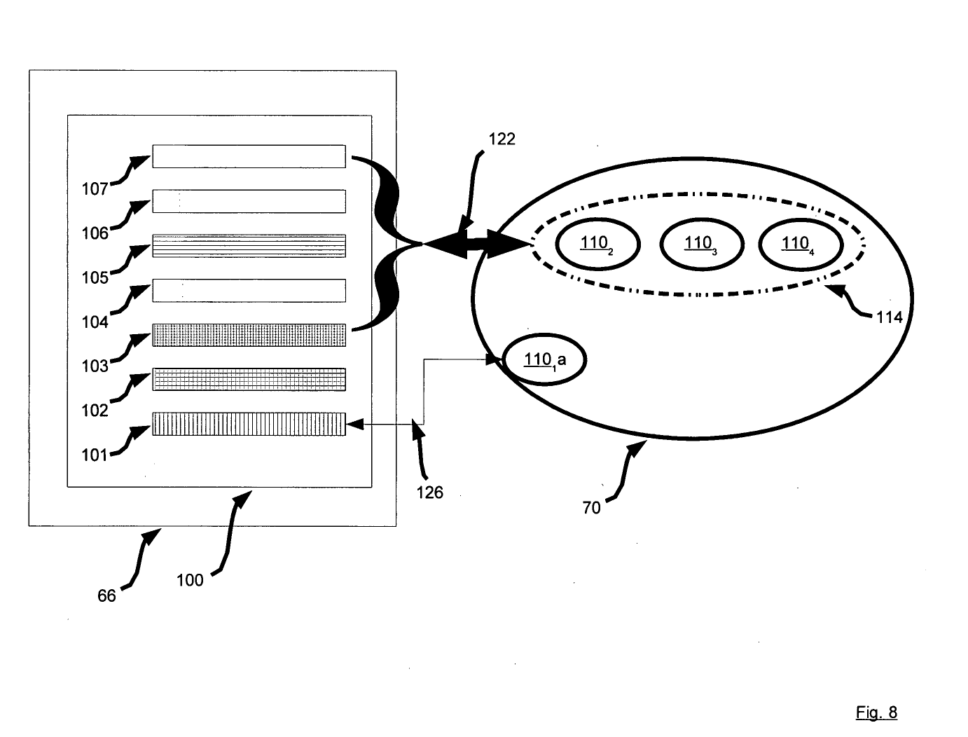

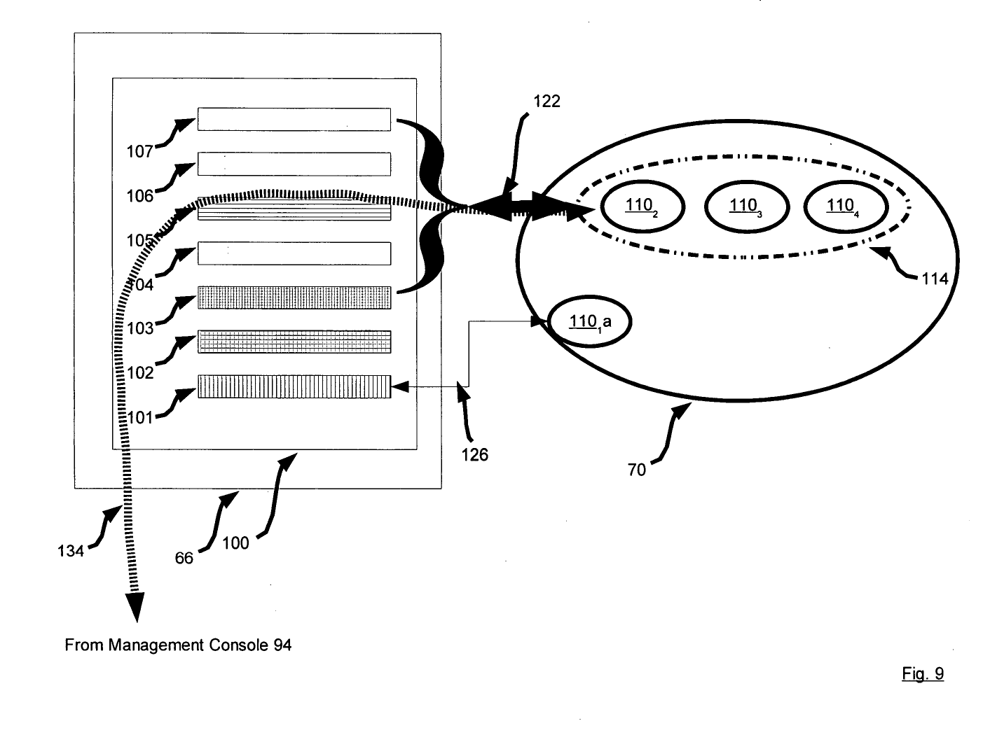

At step 430, the in-band management session is activated. This step is represented in FIG. 8, wherein object 1101a interacts with the remainder of session 70 in order to place session 70 in the open state. At step 440, the in-band session executes. This step is represented in FIG. 9, wherein management console 94 is shown interacting with remaining objects 114 via a virtual link 134. While not required, in a present embodiment, at this point object 1101a will send an acknowledgment to management console 94 that the activation signal was successfully received via layer 103, 104, 105, 106 and/or 107. A customer service representative operating console 94 now has access to all of the configuration tools present in subscriber station 46, and can accordingly interact with authentication object 1102 to help the subscriber at subscriber premises 34 set any user-ids or passwords needed to access Internet 42 via service provider 38. Or, a customer service representative operating console 94 can interact with port-control object 1103 to open or close particular IP ports on subscriber station 46 and thereby control the types of traffic that can be exchanged between Intranet 54 and Internet 42. Or, a customer service representative operating console 94 can interact with DHCP object 1104 to help the subscriber at subscriber premises 34 configure how IP addresses are dynamically assigned to client 58 or other components in Intranet 54. By the same token, a customer service representative operating console 94 can interact with any other configuration tools that may be available on session 70.

Once session 70 is placed in the open state, the means by which management console 94 becomes aware of the IP address of subscriber station 46 (and thereby give access to remaining objects 114), is not particularly limited. For example, where subscriber station 46 has a static IP address within Internet 42 and where that static 1P address is known by service provider 38, then once session 70 is in the open state management console 94 can simply access remaining objects 114 via that known static IP address. Alternatively, where subscriber station 46 dynamically requests a new IP address each time it activates itself on Internet 42, then object 1101a can be configured to both activate session 70 by placing session 70 in the open state, and to cause session 70 to request an IP address from service provider 38 as part of that activation. Once that dynamic IP address is successfully received by session 70, it can be reported back to management console 94 via any suitable manner. One way that the dynamic IP address can be reported back to management console 94 is by providing the IP address of management console 94 to subscriber station 46 as part of the firmware programming of subscriber station 46. Thus, once session 70 is in the open state, session 70 can identify itself (and the dynamic IP address assigned to subscriber station 46) to management console 94. Of course, a failure to report a dynamically assigned IP address back to management console 94 will indicate to management console 94 that there is a technical problem with the equipment outside of subscriber premises 34, and appropriate action can then be taken by service provider 38.

As the management session at step 440 is executed, method 400 will periodically advance to step 450 to determine whether the management session is still valid. If it is valid, method 450 will simply cycle back to step 440. However, if the session is no longer valid, then method 400 advances to step 460 at which point the session is closed and management session 70 will return to the closed state shown in FIG. 6, and method 400 will return to step 410 where it will begin anew.

The criteria used at step 450 to determine whether the session is still valid are not particularly limited. For example, it can be based on a simple inactivity time-out, wherein it is determined that remaining objects 114 have not been executed or utilized despite the fact that session 70 is in the open state. As another criteria used at step 450, management session 70 can be closed in response to a signal sent to object 1101a that instructs object 1101a to close the sessions. As still a further example of criteria that can be used at step 450, session 70 can be configured to immediately and automatically shift to the closed state after one or all of remaining objects 114 have been opened and then closed. As a still further example, an operator at management console 94 can be asked to periodically resubmit a valid user-id and password to subscriber station 46.

Having described method 400 in relation to object 1101a, it is to be reemphasized that system 30, management session 70 and method 400 can operate with other types of out-of-band signals. For example, the interaction with object 1101a over physical layer 101 need not be implemented as a “Sync” signal, but could be implemented simply with a physical push-button switch (or the like) mounted on the exterior of subscriber station 46. In this manner, steps 410 would be effected simply by having a subscriber at premises 34 physically push the button located on subscriber station 46. In this manner, a subscriber at premises 34 engaged in a telephone call with the representative at console 94 can be instructed by the customer service representative to depress the button on the subscriber station 46 in order to activate the management session 70. In this variation, authentication at step 420 can be dispensed with, or it can be effected by having the customer service representative at console 94 enter a user-id and password that is known to subscriber station 46. Other types of physical layer activations will now occur to those of skill in the art.

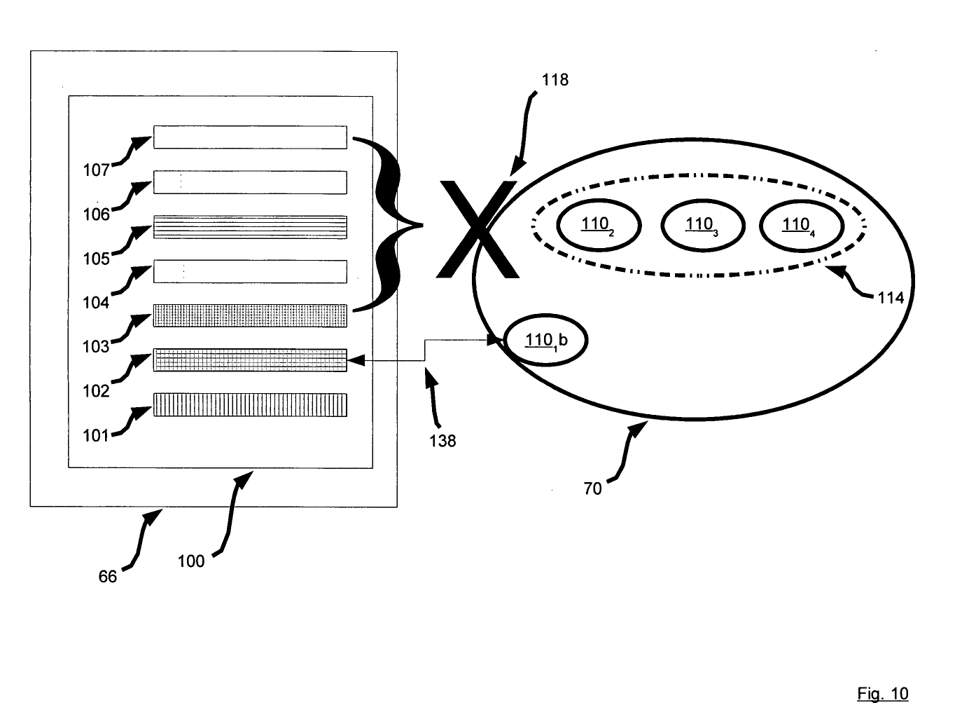

It is also to be understood that the out-of-band activation need not occur over physical layer 101. For example, in FIG. 10 and object 101b is shown. Object 1101b is operable to ‘listen’ for communications sent over layer 102 of protocol stack 100, as represented by link 138. The types of communications for which object 1101b will conform to the types of communications that are reserved for layer 102. For example, those of skill in the art will be familiar with the status query codes proposed in the International Telecommunications Standard (“ITU”) Telecommunication Standardization Sector (“ITU-T”) G.992.1, dated July 1999 (the contents of which are incorporated herein by reference), currently defined codes are for determining the status of layer 102. The inventor of the present invention proposes to make use of the vendor proprietary port of the standard for the purpose of out-of-band activation of a subscriber station such as subscriber station 46 from the DSLAM 82 over layer 102 utilizing object 1101b or the like. In this variation, object 1101b can also be configured to send an acknowledgment to management console 94 that the activation signal was successfully received via layer 102 as part of the authentication at step 420.

While only specific combinations of the various features and components of the present invention have been discussed herein, it will be apparent to those of skill in the art that desired subsets of the disclosed features and components and/or alternative combinations of these features and components can be utilized, as desired. For example, while system 30 in FIG. 1 includes a variety of POTS equipment, including telephone 66, switch 90 and PSTN 42, it is to be understood that these elements can all be omitted in other embodiments of the invention.

While subscriber station 46 includes the functionality of a traditional xDSL modem it is to be understood that subscriber station 46 can also include the functionality of other devices, such as a firewall, router and gateway, either individually or in combination. For example, in another embodiment of the invention a firewall can be provided that has a in-band management session that can be activated through an out-of-band signal.

As an additional example, other, or additional, types of authentication can be employed at step 420 than previously described. For example, management console 94 can be presented with a login screen asking for a user-id and password that is known to subscriber station 46. If the operator at management console 94 (or a hacker attempting to access subscriber station 46 via Internet 42) fails to enter the correct user-id and password, authentication will fail and method 400 will return from step 420 back to step 410.

A still further means of activating management session 70 out-of-band (i.e. without using any of layers 103, 104, 105, 106 and 107), is to associate a table with object 1101 that is stored in session 70. The table will include a number of preset times and dates during which management session 70 is automatically activated and made available to management console 94 or the like. In this particular variation, it is contemplated that management session 70 will require authentication of any user at management console 94 prior to granting that user access to remaining objects 114.

A still further means of activating management session 70 out-of-band is by configuring management session 70 to recognize a predefined series of Dual Tone Multi Frequency (“DTMF”) tones over a voice connection made with subscriber station 46 via twisted pair 66 using the POTS network inherent to a service provider 38 offering xDSL services.

Further security can be added to method 400 by having steps 430 and 440 occur over a secure socket layer (“SSL”) or other encrypted channel between subscriber station 46 and management console 94. Still further security can be employed by only allowing management session 70 to communicate with predefined IP addresses that are proprietary to service provider 38.

Furthermore, while the embodiments discussed herein primarily contemplate control of subscriber station 46 from management console 94, it should be understood that the teachings herein can be employed to provide control of subscriber station 46 from other points outside of, or inside of, subscriber premises 34. Accordingly, management session 70 can be configured, if desired, to allow control over subscriber station 46 to any party located on Internet 42.

As a still further variation, it is contemplated that management session 70 can include the ability to allow various services to be switched “on” or “off”. For example, where service provider 38 offers Voice Over Internet Protocol (“VOIP”) services, then additional objects 110 can be added to session 70 that can be used to alternatively activate or deactivate the ability of a subscriber using Internet 42 to make use of such VOIP services. As another example, where service provider 38 is able to offer cable television or pay television services or the like, then additional objects 110 can be added to session 70 that can be used to alternatively activate or deactivate the such video services. It is contemplated that such functionality may be of immediate interest to service providers offering Internet services over cable or satellite links, and of future use to the extent that video over xDSL becomes more prevalent. As a still further example, where a subscriber chooses to pay reduced fees for reduced bandwidth access to Internet 42, (or increased fees for increased bandwidth) then additional objects 110 can be locally stored in session 70 to regulate the rate that traffic enters or leaves subscriber station 46 according to the subscriber's choice. Other types of services and/or subscription offerings will now occur to those of skill in the art.

It is also contemplated that management session 70 can include functionality to allow it to update itself or portions of itself, by way of activating a connection with an update service maintained by service provider 38 or elsewhere on Internet 42. Such updates can be automatically performed by session 70, or invoked manually by a user anywhere within system 30 that is authenticated. Such updates may involve adding, removing, changing, activating or deactivating various ones of remaining objects 114 according to changing services offered by service provider 38, and/or changes to subscriptions for such services by the subscriber at subscriber premises 34. In this manner, as new functionality and/or services become available, additional objects 110 can be added to remaining objects 114 without having to physically swap out one subscriber station for another. Management session 70 can also include other functionality directed to maintenance of subscriber station 46, such as periodically verifying that the set of remaining objects 114, and their states, correspond with the subscriber's actual service subscription, thereby ensuring the subscriber is receiving services that correspond to the subscriber's agreement with the service provider. The invocation of such periodic verification can be based on a predefined schedule, or it can be invoked remotely by the service provider—either manually via an operator located at management console 94, or automatically by software that is located at an unmanned version management console 94 that is configured to automatically, and periodically, activate management session 70 in order to perform a verification of the subscriber's subscription. The appropriate implementation of management console 94 can thus allow a management application running on console 94 to interoperate with the management session 70 at a peer-to-peer level without any human intervention.

Subscriber station 46 and its variants can allow a service provider to verify connectivity between a subscriber premises and the service provider without the need for dispatching a service technician to the subscriber premises. For example, where management session 70 includes an object 110 in remaining objects 114 that is operable to request an external IP address for subscriber station 46 (i.e. to identify subscriber station 46 on Internet 42) from service provider 38, then a user at management console 94 can utilize object 1101 to remotely activate that management session 70. At this point, object 1101 can then be instructed to interact with the appropriate one of remaining objects 114, and thereby cause subscriber station 46 to make the request for the IP address from service provider 38. The success or failure of such a request can then be reported back to management console 94 via object 1101. If there is a failure, then the user at management console 94 can assign a technician from service provider 38 to troubleshoot the problem, looking for problems that can lie along twisted pair 62 or at central office 74. However, if the request for the IP address is successful, the user at management console 94 can notify the subscriber that any problems must lie within subscriber premises 34, thereby improving operating efficiencies for service provider 38. A successful request for the IP address can be additionally coupled with instructing subscriber station 46 to report that IP address back to management console 94, (i.e. by providing object 1101 with the IP address of management console 94 so that subscriber station 46 knows how to reach management console 94 via layers 103 through 107) thereby allowing management console 94 to use the IP address of subscriber station 46 to interact with the remaining objects 114 in management session 70. Such connectivity verification can be applied to other types of last-mile solutions as well that utilize a subscriber station according to the teachings herein. Also, such connectivity verification can be used in conjunction with the connectivity verification techniques included in U.S. patent application Ser. No. 10/670,261 filed on Sep. 26, 2003, the contents of which are incorporated herein by reference.

As an additional example, while management console 94 has been discussed as being operated by a user or customer service representative, it should be understood that in some circumstances it can be desired to use automated software to operate console 94 and thereby interact with subscriber station 46. For example, where it is desired to check connectivity between service provider 38 and subscriber station 46, a subscriber can simply interact with an over the telephone with an interactive voice response (“IVR”) system located at service provider 38, to instruct management console 94 to conduct such connectivity tests. The IVR system can then report back the results of such tests over the telephone back to the subscriber.

Management session 70 can also include a number of objects 110 that are directed to specialized diagnostics of the IP connection along various points in the system. As a simple example, one such object could be a “ping” command that can be invoked remotely by management console 94. As management console 94 instructs subscriber station 46 to “ping” specified IP addresses in Intranet 54, Internet 42 or within service provider 38, management console 94 can thus be provided with some basic network statistics about packet throughput from subscriber station 46 to those specified IP addresses. Other more sophisticated types of Quality of Service (QoS) diagnostic tools can also be provided in management session 70. In this manner, an operator at management console 94 can periodically perform diagnostics over various portions of all subscriber premises that connect to service provider 38.

It is to be reemphasized that other configurations of system 30 are possible. For example, service provider 38 need not actually own or operate both central office 74 and control centre 78. Instead, service provider 38 may own central office 74, but the services provided at control centre 78 can be provided on an out-source basis, to another service provider or to some other independent third party altogether.

The above-described embodiments of the invention are intended to be examples of the present invention and alterations and modifications may be effected thereto, by those of skill in the art, without departing from the scope of the invention which is defined solely by the claims appended hereto.

1. A method of controlling a subscriber station comprising the steps of:
receiving an activation signal at a subscriber station over an out-of-band link; and,
responsive to said activation signal, activating a management session over an in-band link.

2. The method of claim 1 further comprising the step of authenticating said out-of-band activation signal.

3. The method of claim 1 further comprising the step of terminating said management session upon occurrence of a predefined event.

4. The method of claim 3 wherein said predefined event is selected from the group consisting of an in-band signal (message, command, etc) sent to the managements session and a second out-of-band signal received at said subscriber station.

5. The method of claim 3 wherein said predefined event is an expiry of a period of inactivity of said management session.

6. A subscriber station comprising:
first and second interfaces for connection to first and second networks respectively, each of said networks having a first medium associated therewith;
a microprocessor interconnecting said interfaces for communicating transmissions between said networks;
a persistent storage device connected to said microprocessor for storing a management session executable on said microprocessor, said management session operable to control said transmissions according to configurations made to said management session over said first medium, said management session being activatable on said microprocessor via an activation signal sent over another medium that is different from said first medium.

7. The subscriber station of claim 6 wherein said subscriber station includes functionality selected from the group consisting of an xDSL modem, a cable modem, a set-top box and a wireless local loop subscriber station.

8. The subscriber station of claim 6 wherein said subscriber station is an xDSL modem and said first interface is connectable to a DSLAM via a twisted pair.

9. The subscriber station of claim 8 wherein said second interface is connectable to a client via an Intranet, said subscriber station operable to carry Internet communications between said client and said DSLAM.

10. The subscriber station of claim 6 wherein said second network is a link for connection to a computing device.

11. The subscriber station of claim 6 wherein said first network is the Internet and said second network is an Intranet.

12. The subscriber station of claim 11 wherein said first medium includes at least one of layers three through seven of the OSI reference model.

13. The subscriber station of claim 12 wherein said another medium is layer one of the OSI reference model.

14. The subscriber station of claim 13 wherein said subscriber station is an xDSL modem and said signal includes at least one “Sync” signal.

15. The subscriber station of claim 14 wherein said signal includes a plurality of “Sync” signals sent over predetermined intervals recognizable to said management session.

16. The subscriber station of claim 12 wherein an activation signal used for activation of said management session is based on activation of a physical switch located on an exterior of said subscriber station.

17. The subscriber station of claim 13 wherein said another medium is layer two of the OSI reference model.

18. The subscriber station of claim 17 wherein said activation signal used for activation of said management session is based on a predefined code sent via vendor proprietary segment of the specification as defined in International Telecommunications Standard (“ITU”) Telecommunication Standardization Sector (“ITU-T”) G. 992.1, dated July 1999.

19. The subscriber station of claim 6 wherein said configurations are made over a secure channel established over said first medium.

20. The subscriber station of claim 19 wherein said first network is the Internet, said management session is a web-based application, and said secure channel is a secure socket layer (“SSL”).

21. The subscriber station of claim 6 wherein said management session requires authentication of a user at least once after activation and prior to permitting changes to said configurations.

22. The subscriber station of claim 6 wherein said management session sends an acknowledgement to a source of said signal after receipt thereof.

23. The subscriber station of claim 6 wherein a source of said signal is a management console associated with a service provider respective to said subscriber station.

24. The subscriber station of claim 6 wherein said configurations include changes to a subscription of services associated with said subscriber station and which are provided by a service provider.

25. The subscriber station of claim 24 wherein said management session includes a software object for verifying said configurations corresponds to said subscription.

26. The subscriber station of claim 25 wherein said software object can be periodically invoked and results therefrom reported to a management console associated with said service provider.

27. A method of testing for connectivity over a first medium between a subscriber station at a subscriber premises and a service provider comprising the steps of:
sending an activation signal over another medium different from said first medium to said subscriber station;
responsive to said activation signal, activating a management session resident at said subscriber station over said first medium;
proving connectivity if said management session communicates via said first medium with a management console that is located outside of said subscriber premises;
disproving connectivity if said management session does not communicate via said first medium with said management console.

28. A method of testing for connectivity over a first medium between a subscriber station at a subscriber premises and a service provider comprising the steps of:
sending an activation signal over another medium different from said first medium to said subscriber station;
responsive to said activation signal, activating said subscriber station connection over said first medium; and,
proving connectivity if said subscriber station communicates via said first medium with a management console that is located outside of said subscriber premises.

29. The method of claim 28 further comprising the step of disproving connectivity if said subscriber station does not communicate via said first medium with said management console.

30. The method of claim 28 wherein said subscriber station includes functionality selected from the group consisting of an xDSL modem, a cable modem, a set-top box and a wireless local loop subscriber station.

31. The method of claim 28 wherein said first medium includes at least one of layers three through seven of the OSI reference model.

32. The method of claim 28 wherein said another medium is layer one of the OSI reference model.

33 The method of claim 29 wherein said subscriber station is an xDSL modem and said signal includes at least one “Sync” signal.

34. The method of claim 29 wherein said signal includes a plurality of “Sync” signals sent over predetermined intervals recognizable to said management session.

35. The method of claim 28 wherein said signal is based on activation of a physical switch located on an exterior of said subscriber station.

36. The method of claim 28 wherein said another medium is layer two of the OSI reference model.

37. The method of claim 28 wherein said activation signal is based on a predefined code

38. The method of claim 37 wherein said predefined code is sent via vendor proprietary segment of the specification as defined in International Telecommunications Standard (“ITU”) Telecommunication Standardization Sector (“ITU-T”) G. 992.1.

39. The method of claim 28 wherein said subscriber station requires authentication of a user at least once after activation.

40. The method of claim 28 further comprising the step sending an acknowledgement to a source of said signal after receipt thereof regardless of whether said connectivity is proved or disproved.

41. The method of claim 28 wherein a source of said signal is a management console associated with a service provider respective to said subscriber station.

42. An activation signal sent over a first communication medium to a subscriber station which upon receipt by said subscriber station is for causing said subscriber station to attempt communication over another communication medium different from said first communication medium.

43. A computer readable medium for storing a management session executable by a microprocessor on a subscriber station, said subscriber station including first and second interfaces for connection to first and second networks respectively, each of said networks having a first medium associated therewith; said subscriber station operable to interconnect said interfaces for communicating transmissions between said networks, said management session operable to control said transmissions according to configurations made to said management session over said first medium, said management session being activatable on said microprocessor via an activation signal sent over another medium that is different from said first medium.

44. The medium according to claim 43 wherein said configurations include changes to a subscription of services associated with said subscriber station and which are provided by a service provider.

45. The medium according to claim 43 wherein said management session includes a software object for verifying said configurations corresponds to said subscription.

46. The medium according to claim 43 wherein said software object can be periodically invoked and results therefrom reported to a management console associated with said service provider.
